(19) United States
(12) Patent Application Publication
(10) Pub. No.: US 2026/0029694 A1
(43) Pub. Date: Jan. 29, 2026

(54) IMAGE CAPTURING APPARATUS EQUIPPED WITH STAND

(71) Applicant: CANON KABUSHIKI KAISHA, Tokyo (JP)

(72) Inventor: TAKAZUMI SEO, Tokyo (JP)

(21) Appl. No.: 19/350,387

(22) Filed: Oct. 6, 2025

Related U.S. Application Data
(63) Continuation of application No. PCT/JP2024/014014, filed on Apr. 5, 2024.

(30) Foreign Application Priority Data
Apr. 14, 2023 (JP) 2023-066396

(51) Int. Cl. G03B 17/56; H04N 23/51; H04N 23/53; H04N 23/54

(52) U.S. Cl. CPC G03B 17/561; G03B 17/565; H04N 23/51; H04N 23/531; H04N 23/54

(57) ABSTRACT

An image capturing apparatus 1 has a barrel unit 2 and a tripod screw portion 35a, and includes a tripod attaching portion 35 disposed with respect to the barrel unit 2 in a Y direction orthogonal to a Z direction as an optical axis direction, a battery 80 disposed between the barrel unit 2 and the tripod attaching portion 35 in the Y direction, and a stand 9 which is held rotatable about a rotational axis A2 parallel to an X direction orthogonal to the Z direction and the Y direction and has a connection portion connecting leg portions provided at ends in the X direction. The battery 80 is plate-like and has a rectangular parallelepiped shape, and at the same time is disposed such that a thickness direction thereof is parallel to the Z direction. The tripod screw portion 35a is exposed to appearance in a bottom surface of the image capturing apparatus 1. The rotational axis A2 overlaps the tripod screw portion 35a on a projection plane as viewed in the X direction, and at the same time, overlaps the tripod screw portion 35a, the battery 80, and the barrel unit 2 on a projection plane as viewed in the Y direction.

### CROSS-REFERENCE TO RELATED APPLICATIONS

This application is a Continuation of International Patent Application No. PCT/JP 2024/014014, filed Apr. 5, 2024, which claims the benefit of Japanese Patent Application No. 2023-066396, filed Apr. 14, 2023, both of which are hereby incorporated by reference herein in their entirety.

### BACKGROUND

### Field of the Technology

The present disclosure relates to an image capturing apparatus equipped with a stand.

### Description of the Related Art

Shooting is sometimes performed in a state in which a tripod is attached to a tripod screw formed in a bottom surface of an image capturing apparatus, and the image capturing apparatus is set to a desired angle. However, in a case where a user performs shooting using a tripod, the user is required to carry the tripod, which is troublesome. Further, it takes time to perform setting at a time of shooting. To cope with this, for example, Patent Literature 1 discloses an image capturing apparatus that is equipped with a stand on a rear surface of an apparatus body and has a tripod screw formed in the stand. A user can place the image capturing apparatus in a predetermined position using the stand and perform shooting at a desired angle according to a shooting scene. The user can also perform shooting at a desired angle using a tripod.

Patent Literature 1: Japanese Patent Laid-Open No. 2000-284357

In the image capturing apparatus disclosed in the above-mentioned Patent Literature 1, in a case where the stand is not used, the stand is accommodated in the rear surface of the image capturing apparatus body, and the stand is formed with the tripod screw. Therefore, the image capturing apparatus body is formed into a flat shape as a whole and can be reduced in thickness. However, from a viewpoint of reduction of the thickness of the image capturing apparatus body, the stand cannot be arranged such that it overlaps a member which is relatively thick, such as a battery and an operation section, in the thickness direction of the image capturing apparatus body. Therefore, from the viewpoint of reduction of the thickness of the image capturing apparatus body, it is impossible to avoid increasing the image capturing apparatus body in the width and/or height direction(s). Further, there is a concern that the stability at a time when the image capturing apparatus is caused to independently stand using the stand is lowered due to an increase in the image capturing apparatus body in the width and/or height direction(s).

### SUMMARY

The present disclosure provides an image capturing apparatus that is capable of enhancing the stability at a time when the image capturing apparatus is caused to independently stand using a stand while preventing an increase in the size of the image capturing apparatus.

An image capturing apparatus according to the present disclosure includes a barrel unit, an accessory attachment/removal portion disposed in a second direction orthogonal to a first direction which is an optical axis direction of the barrel unit, with respect to the barrel unit, for attaching and removing an accessory, a battery disposed between the barrel unit and the attachment/removal portion in the second direction; and a stand rotatably held about a stand rotational axis, as a center, which is parallel to a third direction orthogonal to the first direction and the second direction, wherein the battery has a plate shape and is disposed such that a thickness direction thereof is parallel to the first direction, wherein the stand has two leg portions disposed at respective ends of the image capturing apparatus in the third direction, and a connection portion connecting the two legs in the third direction, wherein the accessory attachment/removal portion is exposed to appearance in a bottom surface of the image capturing apparatus, and wherein the stand rotational axis overlaps the accessory attachment/removal portion on a projection plane as viewed in the third direction, and at the same time, overlaps the accessory attachment/removal portion, the battery, and the barrel unit on a projection plane as viewed in the second direction.

According to the present disclosure, it is possible to enhance, with respect to an image capturing apparatus equipped with a stand, the stability at a time when the image capturing apparatus is caused to independently stand using the stand while preventing an increase in the size thereof.

Features of the present disclosure will become apparent from the following description of embodiments with reference to the attached drawings.

### BRIEF DESCRIPTION OF THE DRAWINGS

FIG. 1A is a perspective view of the appearance of an image capturing apparatus according to embodiments.

FIG. 1B is a perspective view of the appearance of the image capturing apparatus according to the embodiments.

FIG. 1C is a bottom view of the image capturing apparatus according to the embodiments.

FIG. 2A is a perspective view showing the appearance of the image capturing apparatus at a time when a display section is in an opened state and at the same time a stand is in an accommodated state.

FIG. 2B is a perspective view showing the appearance of the image capturing apparatus at a time when the display section is in the opened state and at the same time the stand in in a rotated state.

FIG. 2C is a side view useful in explaining movement of the display section and the stand at a time when the stand is rotated in a case where the display section is in an accommodated state.

FIG. 3A is a side view showing a state of the image capturing apparatus at the time of low-angle shooting.

FIG. 3B is an enlarged perspective view of a bottom part of the image capturing apparatus at the time of low-angle shooting.

FIG. 3C is a side view showing a state of the image capturing apparatus at the time of high-angle shooting.

FIG. 3D is an enlarged perspective view of the bottom part of the image capturing apparatus at the time of high-angle shooting.

FIG. 4A is an exploded perspective view of a stand hinge according to a first embodiment.

FIG. 4B is an exploded perspective view of the stand according to the first embodiment.

FIG. 5A is an exploded perspective view of a stand hinge according to a second embodiment.

FIG. 5B is an exploded perspective view of a stand hinge according to a third embodiment.

FIG. 6A is an exploded perspective view showing a configuration of the exterior of the image capturing apparatus.

FIG. 6B is a rear view showing a state in which the stand has been fixed to a front cover unit.

FIG. 7A is an exploded perspective view useful in explaining a configuration of an internal structure unit of the image capturing apparatus.

FIG. 7B is a perspective view useful in explaining a configuration of the internal structure unit of the image capturing apparatus.

FIG. 8A is a view useful in explaining a layout of components of the internal structure unit of the image capturing apparatus.

FIG. 8B is a view useful in explaining the layout of the components of the internal structure unit of the image capturing apparatus.

FIG. 8C is a view useful in explaining the layout of the components of the internal structure unit of the image capturing apparatus.

### DESCRIPTION OF THE EMBODIMENTS

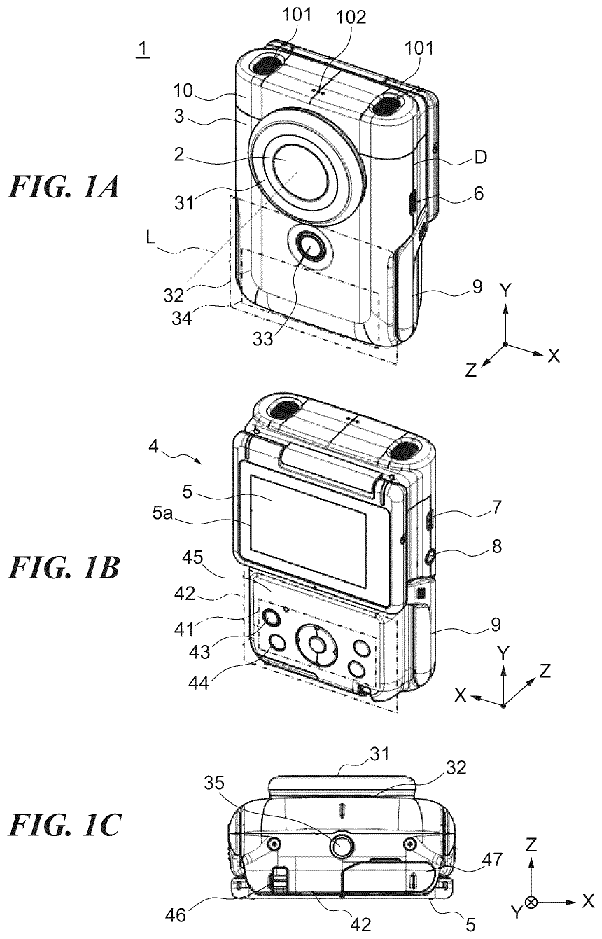

Embodiments of the present disclosure will now be described in detail below with reference to the accompanying drawings. FIG. 1A is a front-side perspective view (appearance perspective view, as viewed obliquely from the front) of an image capturing apparatus 1 according to embodiments. FIG. 1B is a rear-side perspective view (appearance perspective view, as viewed obliquely from the rear) of the image capturing apparatus 1. FIG. 1C is a bottom view of the image capturing apparatus 1. For convenience of explanation, an X direction, a Y direction, and a Z direction, which are orthogonal to each other, are defined with respect to the image capturing apparatus 1, as shown in FIGS. 1A to 1C, as follows: A thickness direction of the image capturing apparatus 1 is defined as the Z direction (first direction), a vertical direction (height direction) of the image capturing apparatus 1 is defined as the Y direction (second direction), and a right-left direction (width direction) of the image capturing apparatus 1 is defined as the X direction (third direction).

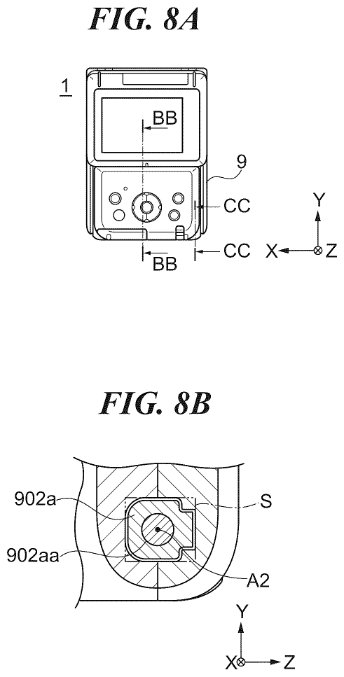

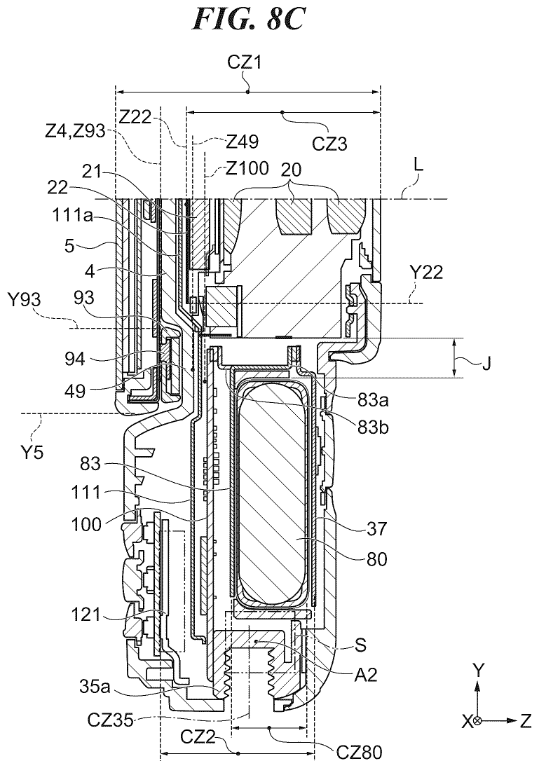

On a front surface (surface on the +Z side) of the image capturing apparatus 1, a lens barrel unit 2 (hereinafter after referred to as the “barrel unit 2”) having a shooting optical system is disposed. The barrel unit 2 is e.g. a fixed-type single focus lens, and a shutter mechanism, a focus mechanism, and so forth are mounted inside the barrel unit 2. Even when the power of the image capturing apparatus 1 is switched from off to on, the barrel unit 2 is not extended. Further, the barrel unit 2 has an image sensor 21 (see FIG. 8C) that generates image data by photoelectrically converting an object optical image formed through a plurality of photographic lenses 20 (see FIG. 8C) as the components of the shooting optical system.

Note that in the image capturing apparatus 1, a direction of an optical axis L (optical axis direction) of the barrel unit 2 is parallel to the Z direction. The configuration of the barrel unit 2 can be a configuration of a known lens barrel as described above. The configuration of the barrel unit 2 is not directly related to the characteristic configuration of the present disclosure, and hence detailed description thereof is omitted.

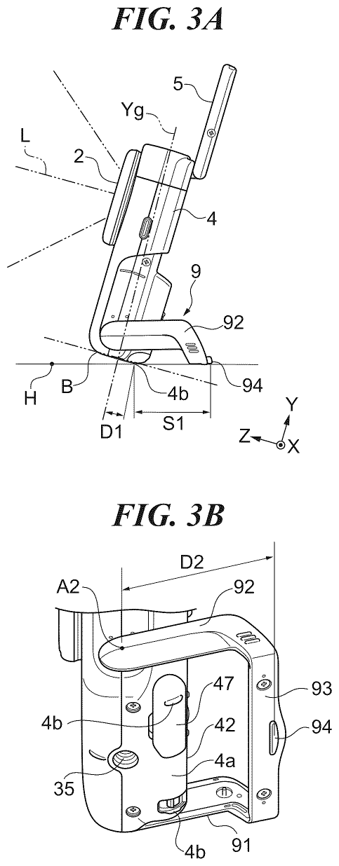

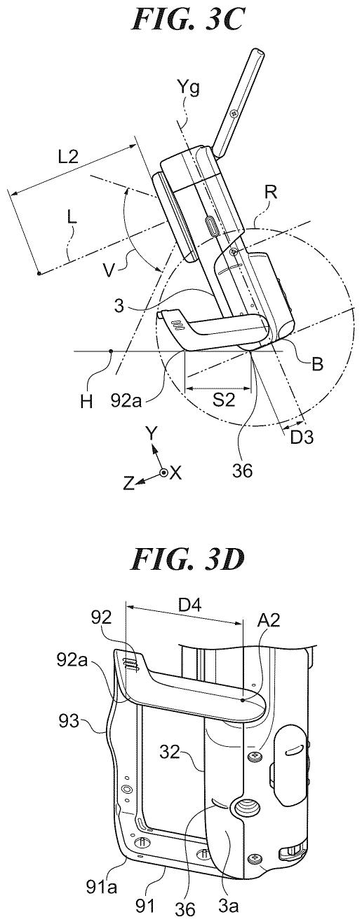

The appearance of the front surface of the image capturing apparatus 1 is formed by a front cover 3. The front cover 3 is provided with a front ring 31 on the outer periphery of the barrel unit 2, which is protruded one step toward the +Z side (forward). On the −Y side (lower side) of the front ring 31, there is arranged a front grip part 32 for being gripped by a user when holding the image capturing apparatus 1. Since the front ring 31 is protruded toward the +Z side more than the front grip part 32 in the Z direction, when the user holds the image capturing apparatus 1, the user naturally grips the front grip part 32 arranged on the −Y side of the front ring 31. That is, the front ring 31 plays the role of a mark for gripping the front grip part 32 when the user holds the image capturing apparatus 1. Therefore, it is possible to prevent a user's hand holding the image capturing apparatus 1 from entering a shooting view angle V (see FIG. 3C) of the barrel unit 2.

A start/stop button 33 is disposed at a location on the −Y side of the front ring 31 and at the same time on the +Y side (upper side) in the front grip part 32. When the start/stop button 33 is once pressed, shooting is started. When the start/stop button 33 is pressed again, shooting is terminated. An area of the front grip part 32 on the −Y side of the start/stop button 33 is a front-surface finger placing space 34 on which the user places fingers when holding the image capturing apparatus 1.

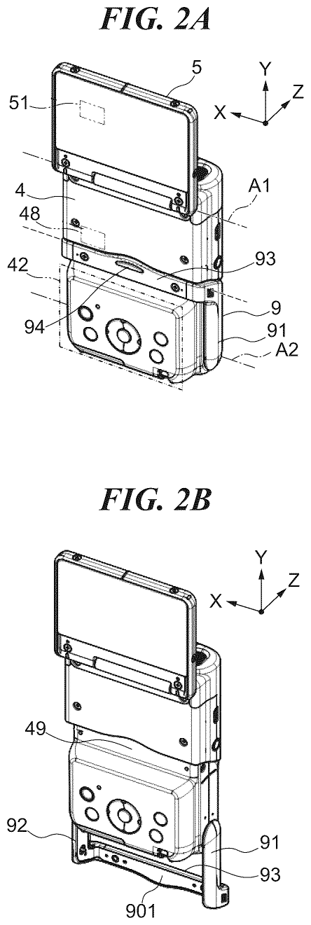

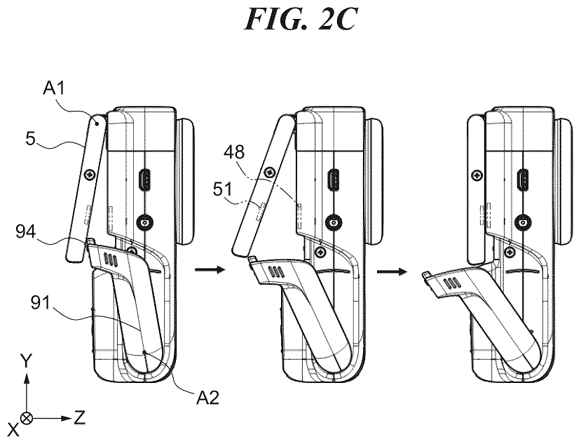

The appearance of the rear surface of the image capturing apparatus 1 is formed by a rear cover 4 (also see FIGS. 2A to 2C as required). The rear surface of the image capturing apparatus 1 is provided with a display section 5 and a rear operation section 41 including a plurality of buttons. The display section 5 is formed by disposing a touch panel 5a capable of detecting a touch operation of a user in a state superposed on a screen of a Thin Film Transistors (TFT)-type liquid crystal display device. In a case where the image capturing apparatus 1 is in a power-on state and is set to a still image mode or a moving image mode, an object image (through image) captured by the image sensor 21 is displayed on the display section 5.

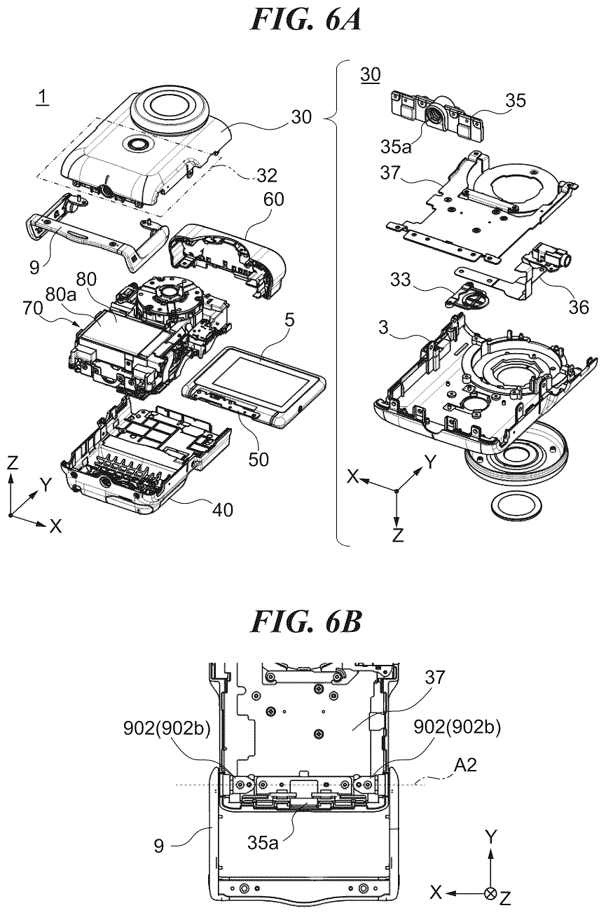

The display section 5 is connected to a main body (hereinafter referred to as the “apparatus body”) of the image capturing apparatus 1 by a display section hinge 50 (see FIG. 6A) disposed in the vicinity of a top surface of the image capturing apparatus 1. Note that the apparatus body is, in other words, part of the image capturing apparatus 1, formed by removing the display section hinge 50, the display section 5, and a stand 9, described hereinafter, from the image capturing apparatus 1.

The display section hinge 50 has a display section rotational axis A1 (hereinafter referred to as the “rotational axis A1”) (see FIG. 2A) parallel to the X direction and can rotate the display section 5 about the rotational axis A1 through approximately 180°. FIGS. 1A to 1C each show a state of the display section 5 accommodated in the rear surface of the image capturing apparatus 1. In this state, the rotational angle of the display section 5 is 0°, the screen of the display section 5 is substantially orthogonal to the Z direction, and at the same time, the display section 5 (area of the display section 5) overlaps the apparatus body (area of the apparatus body) on a projection plane as viewed in the Z direction. Note that a state of the display section 5 rotated through a rotational angle of approximately 180° (hereinafter referred to as the “opened state”) is shown in FIGS. 2A and 2B. By placing the display section 5 in the opened state, when the user takes a selfie by holding the camera 1, the user can perform shooting while checking a composition on the display section 5.

On the −Y side of the display section 5, a rear grip part 42 for being gripped by a user to hold the image capturing apparatus 1 is disposed such that the rear grip part 42 is one step lower than the display section 5 in the +Z direction. Note that the grip part of the image capturing apparatus 1 is formed by the front grip part 32 and the rear grip part 42.

Since the display section 5 protrudes toward the −Z side with respect to the rear grip part 42, when the user holds the image capturing apparatus 1, the user naturally grips the rear grip part 42 disposed on the −Y side of the display section 5 and holds the image capturing apparatus 1. That is, the display section 5 plays the role of a mark for gripping the rear grip part 42 when the user holds the image capturing apparatus 1. Therefore, it is possible to prevent a user's hand holding the image capturing apparatus 1 from touching an area of the touch panel 5a of the display section 5.

The rear operation section 41 is provided in an area of the rear grip part 42 on the −Y side. The rear operation section 41 includes a power button 43 for switching power-on/off of the image capturing apparatus 1 and a reproduction button 44 for instructing reproduction of a captured image which has been captured (stored). When the reproduction button 44 is pressed, the captured image is displayed on the display section 5. Description of buttons other than the power button 43 and the reproduction button 44 is omitted.

In an area of the rear grip part 42 on the +Y side, a rear-surface finger placing space 45 on which the user places fingers when holding the image capturing apparatus 1 is provided. On the rear surface of the image capturing apparatus 1, the rear-surface finger placing space 45 is provided at a location opposite to the start/stop button 33 provided on the front surface of the image capturing apparatus 1. Further, on the front surface of the image capturing apparatus 1, the front-surface finger placing space 34 is provided at a location opposite to the rear operation section 41. With this arrangement, the user can grip the image capturing apparatus 1 such that the image capturing apparatus 1 is sandwiched between an operation member to be operated and the front and rear finger placing spaces in the Z direction. This enables the user to positively perform an operation of pressing the operation member.

The appearance of the side surfaces (end faces in the X direction) of the image capturing apparatus 1 is formed by the front cover 3 and the rear cover 4. On a contact line D as a meeting position between the front cover 3 and the rear cover 4 in the Z direction, there are arranged jacks to connect to external devices, such as a power supply external connector 6 (hereinafter referred to as the “external connector 6”), an HDMI (registered trademark) connector 7, and a microphone input terminal 8. These jacks are arranged on the +Y side of the front grip part 32 and the rear grip part 42, i.e. arranged in an area overlapping the barrel unit 2 on a projection plane as viewed in the X direction. Therefore, in a case where the user holds the image capturing apparatus 1 or in a case where the user performs shooting by placing the image capturing apparatus 1 e.g. on a desk, in a state in which cables are inserted in the respective jacks, the user can perform shooting without being obstructed by any of the cables inserted in the jacks. Thus, in the image capturing apparatus 1, the user-friendliness at a time when a cable is used is improved.

The stand 9 is provided on the side surfaces of the grip parts (the front grip part 32 and the rear grip part 42) of the image capturing apparatus 1. Note that a state of the stand 9 substantially entirely in close contact with the apparatus body as shown in FIGS. 1A to 1C is defined as a “an accommodated state of the stand 9”.

The stand 9 has stand side covers 91 and 92 (see FIGS. 2A to 2C), disposed on opposite ends of the image capturing apparatus 1 in the X direction. When the stand 9 is in the accommodated state, the stand side covers 91 and 92 form the appearance of the image capturing apparatus 1, and at this time, the stand side covers 91 and 92 form substantially the same shape as the side surface shape of the front cover 3 and the rear cover 4. Therefore, the stand 9 is configured to give no strange impression in the appearance and not to interfere with a user holding the image capturing apparatus 1.

The appearance of the top surface of the image capturing apparatus 1 is formed by a top cover 10. On the top surface of the top cover 10, which is the top surface positioned on the +Y side of the barrel unit 2, microphone holes 101 for microphones are provided. The microphone holes 101 are arranged symmetrically in the X direction with respect to the position of the optical axis L of the barrel unit 2 in the X direction. Further, in a substantially central portion of the top surface of the top cover 10 in the X direction, speaker holes 102 for a speaker that reproduces an operation sound and sound of a captured moving image are provided with a predetermined spacing in the X direction. By providing the microphone holes 101 in the top surface of the image capturing apparatus 1, it is possible to reduce a difference in sound collection performance between the front side and rear side when taking in a sound coming from the front side of the image capturing apparatus 1 and a sound coming from the rear side of the same.

On a bottom surface of the image capturing apparatus 1, there are provided a tripod attaching portion 35 for attaching an accessory, such as a tripod, a strap attaching portion 46 for inserting a strap string, and a media cover 47. The media cover 47 is attached to the apparatus body in an openable/closable state, and when the media cover 47 is opened, it is possible to insert and remove (attach and detach) a storage (not shown), such as an SD card, which is an external memory, into and from the apparatus body.

Next, the movement of the display section 5 and the stand 9 will be described. FIG. 2A is a rear perspective view of the image capturing apparatus 1 at a time when the display section 5 is in the opened state and at the same time the stand 9 is in the accommodated state. The display section 5 is held on the apparatus body in a state rotatable about the rotational axis A1 disposed at a location close to the top surface of the image capturing apparatus 1. A magnet 51 is disposed inside the display section 5 at a location in the vicinity of a reverse surface of the display section 5, and a yoke 48, which is a magnetic material, is disposed inside the rear cover 4 in the vicinity of the front surface of the rear cover 4. When the display section 5 is rotated from the opened state to the accommodated state, the display section 5 receives a mechanical suction force applied by the display section hinge 50 (see FIG. 6A) and a magnetic attractive force applied by the magnet 51 and the yoke 48. With this, the display section 5 is urged toward the accommodating direction at a predetermined angle position and automatically shifted to the accommodated state.

The stand 9 is held on the apparatus body in a state rotatable about a stand rotational axis A2 (hereinafter referred to as the “rotational axis A2”) in the vicinity of the bottom surface of the image capturing apparatus 1. The rotational axis A2 is positioned in the vicinity of the bottom surface of the image capturing apparatus 1 and is parallel to the X direction. For example, by using the stand 9 when shooting is performed by placing the image capturing apparatus 1 on a predetermined structure, it is possible to perform shooting, in a state in which the image capturing apparatus 1 is tilted about the rotational angle A2 at a desired angle. This will be described hereinafter in detail with reference to FIGS. 3A to 3D.

FIG. 2B is a rear perspective view of the image capturing apparatus 1 at a time when the display section 5 is in the opened state and at the same time the stand 9 is in a state rotated through approximately 180° from the accommodated state. Note that the state of the stand 9 rotated from the accommodated state is hereinafter referred to as the “rotated state”.

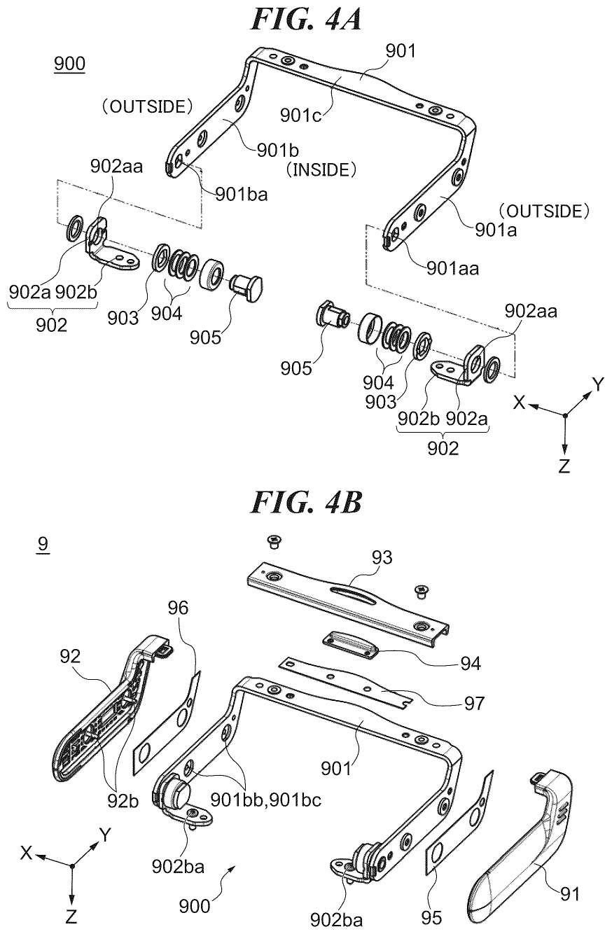

The stand 9 is formed by attaching the stand side covers 91 and 92 (first and second covers) and a stand intermediate cover 93 (third cover), which form the appearance, to a rotational plate 901 (also see FIGS. 4A and 4B as required) made of metal and having a substantially U-shape, as described hereinafter. Therefore, the stand 9 has a substantially U-shape, and the stand side covers 91 and 92 and the stand intermediate cover 93 are rotated in unison. On the stand intermediate cover 93, a cushion member 94 is disposed. The cushion member 94 reduces the collision sound between the display section 5 and the stand 9 when the display section 5 is shifted from the opened state to the accommodated state. Details of the configuration of the stand 9 will be described hereinafter.

The rear cover 4 has a stand accommodating portion 49 formed on the +Y side of the rear grip part 42. The stand accommodating portion 49 accommodates the stand intermediate cover 93 when the stand 9 is in the accommodated state. When the display section 5 is in the accommodated state, the stand accommodating portion 49 is hidden by the display section 5. That is, when the display section 5 is in the accommodated state, and at the same time the stand 9 is in the accommodated state, the stand intermediate cover 93 is covered by the display section 5. As described hereinabove, the rotational axis A1 of the display section 5 is parallel to the X direction and at the same time provided in the vicinity of the end portion of the apparatus body in the +Y direction. Further, the rotational axis A2 of the stand 9 is parallel to the X direction and at the same time provided in the vicinity of the end portion of the apparatus body in the −Y direction. The stand accommodating portion 49 (i.e. the stand intermediate cover 93 at a time when the stand 9 is in the accommodated state) is provided in substantially the center between the rotational axis A1 and the rotational axis A2 in the Y direction.

FIG. 2C is a side view useful in explaining the movement of the display section 5 and the stand 9 at a time when the stand 9 is rotated from the accommodated state when the display section 5 is in the accommodated state. As shown in a left-side view in FIG. 2C, when the stand 9 is rotated from the accommodated state in which the display section 5 is in the accommodated state, the display section 5 is pushed up, in a state in contact with the cushion member 94, by the stand intermediate cover 93.

As shown in the center view in FIG. 2C, the application point of the force applied when the display section 5 is pushed up by the stand intermediate cover 93 is in the vicinity of the end portion of the display section 5 on the −Y side at the time when the display section 5 is in the accommodated state. Therefore, even when a force to rotate the stand 9 is applied to the display section 5 by the user, the display section 5 is not extremely pushed up.

As shown in the right view in FIG. 2C, when the stand 9 is rotated to a predetermined angle, the stand intermediate cover 93 is detached from the reverse side of the display section 5, and the display section 5 is prevented from being pushed up by the stand 9. Then, the display section 5 is automatically returned (shifted) to the accommodated state by the suction force applied by the display section hinge 50 and the magnetic attractive force applied by the magnet 51 and the yoke 48. That is, in a case where the user desires to use only the stand 9, the user is not required to take the trouble of placing the display section 5 in the opened state. Therefore, with this configuration, it is possible to improve the user-friendliness of the stand 9.

An example of a shooting method using the stand 9 will be described. FIG. 3A is a side view showing a state of the image capturing apparatus 1 at the time of low-angle shooting using the stand 9. FIG. 3B is an enlarged perspective view of bottom part of the image capturing apparatus 1 at the time of low-angle shooting shown in FIG. 3A.

As shown in FIG. 3A, low-angle shooting refers to shooting performed by rotating the stand 9 and placing the image capturing apparatus 1 on a structure such that the optical axis L of the barrel unit 2 is directed obliquely upward with respect to a horizontal plane H. When low-angle shooting is performed, the stand 9 is rotated until the stand intermediate cover 93 of the stand 9 is shifted to be positioned more on the −Z side than the rear cover 4, and at the same time positioned more on the +Y side than a bottom surface B of the apparatus body. The rear cover 4 has a fillet (R-curved surface) 4a formed along a ridge line at which the bottom surface B of the apparatus body and the rear grip part 42 meet. Further, the rear cover 4 has protruding leg portions 4b provided thereon such that they protrude from the fillet 4a one by one at a predetermined interval in the X direction, with the tripod attaching portion 35 as the center. Note that one of the protruding leg portions 4b is provided on the media cover 47

As shown in FIG. 3B, when low-angle shooting is performed, the image capturing apparatus 1 is put into a state grounded on the horizontal plane H at three points including the cushion member 94 provided on the stand intermediate cover 93 and the protruding leg portions 4b provided one by one at two locations. With this, the image capturing apparatus 1 is stably placed, i.e. the stability at a time when the image capturing apparatus 1 independently stands is increased. Further, one of the three grounding points is formed by the cushion member 94. With this, even when the user operates the touch panel 5a of the display section 5 during low-angle shooting, a gripping effect with respect to the horizontal plane H is obtained by the cushion member 94, and it is possible to obtain an effect that the image capturing apparatus 1 is difficult to be easily moved in the horizontal direction.

To cause the image capturing apparatus 1 to independently and stably stand in the state of low-angle shooting, it is only required to properly adjust the rotational angle of the stand 9. Specifically, it is only required to adjust the rotational angle of the stand 9 such that the center of gravity of the image capturing apparatus 1 is within a range of a spacing S1 between the protruding leg portions 4b and the cushion member 94 in a direction parallel to the horizontal plane H, as viewed in the X direction. In other words, to enlarge the range of the tilt angle of the image capturing apparatus 1 for low-angle shooting, it is only required to minimize a distance DI between an axis Yg, which passes through the center of gravity of the image capturing apparatus 1 and is parallel to the Y direction, and the protruding leg portions 4b, in the Z direction, by reducing the thickness of the image capturing apparatus 1 in the Z direction. Then, in a step of realizing reduction of the thickness of the image capturing apparatus 1 in the Z direction, it is desirable to increase the spacing S1 between the protruding leg portions 4b and the cushion member 94 by increasing a distance D2 from the rotational axis A2 of the stand 9 to the cushion member 94 to thereby extend the stand 9.

FIG. 3C is a side view showing a state of the image capturing apparatus 1 at the time of high-angle shooting using the stand 9. FIG. 3D is an enlarged perspective view of the bottom part of the image capturing apparatus 1 at the time of high-angle shooting shown in FIG. 3C.

As shown in FIG. 3C, high-angle shooting refers to shooting performed by rotating the stand 9 and placing the image capturing apparatus 1 on a structure such that the optical axis L of the barrel unit 2 is directed obliquely downward with respect to the horizontal plane H. When high-angle shooting is performed, the stand 9 is rotated until the stand intermediate cover 93 of the stand 9 is shifted to be positioned more on the +Z side than the front cover 3 of the image capturing apparatus 1, and is at the same time positioned more on the +Y side than the bottom surface B of the apparatus body. The front cover 3 has a fillet (R-curved surface) 3a formed along a ridge line where the bottom surface B of the apparatus body and the front grip part 32 meet. Further, the front cover 3 has a protruding leg portion 36, which is made of an elastic material having a cushioning property, formed at the center of the fillet 3a in the X direction. Note that the method of disposing the protruding leg portion 36 is not particularly limited. For example, the protruding leg portion 36 can be affixed from inside the front cover 3. Alternatively, the protruding leg portion 36 can be formed on the front cover 3 by two-color molding of elastic materials, as a component integrated with the front cover 3.

As shown in FIG. 3D, when high-angle shooting is performed, the image capturing apparatus 1 is put into a state grounded on the horizontal plane H at three points including the protruding leg portion 36 of the front cover 3 and the fillets 91a and 92a of the stand side covers 91 and 92. With this, the image capturing apparatus 1 is stably placed. Further, one of the three grounding points is formed by the protruding leg portion 36 made of an elastic material. With this, even when the user operates the touch panel 5a of the display section 5 during high-angle shooting, a gripping effect with respect to the horizontal plane H is obtained due to the protruding leg portion 36, and it is possible to obtain an effect that the image capturing apparatus 1 is difficult to be easily moved in the horizontal direction.

To cause the image capturing apparatus 1 to independently and stably stand in the state of high-angle shooting, it is only required to properly adjust the rotational angle of the stand 9. Specifically, it is only required to adjust the rotational angle of the stand 9 such that the center of gravity of the image capturing apparatus 1 is within a range of a spacing S2 between the protruding leg portion 36 and the fillets 91a and 92 in a direction parallel to the horizontal plane H, as viewed in the X direction. In other words, to enlarge the range of the tilt angle of the image capturing apparatus 1 for high-angle shooting, it is only required to minimize a distance D3 between the axis Yg, which passes through the center of gravity of the image capturing apparatus 1 and is parallel to the Y direction, and the protruding leg portion 36, in the Z direction, by reducing the thickness of the image capturing apparatus 1 in the Z direction. Then, in a step of realizing reduction of the thickness of the image capturing apparatus 1 in the Z direction, it is desirable to increase the spacing S2 between the protruding leg portion 36 and the fillets 91a and 92a by increasing a distance D4 from the rotational axis A2 of the stand 9 to the fillets 91a and 92a to thereby extend the stand 9.

In a case where the stand 9 is extended, it is desirable to design the stand 9 such that the shooting view angle V of the barrel unit 2 and a rotation locus R of the stand 9 are prevented from interfering with each other. Further, the barrel unit 2 has a shortest shooting distance L2 determined by the configuration of the photographic lenses 20 (see FIG. 8C). So, it is desirable that the image capturing apparatus 1 can be tilted to a position where the shortest shooting distance L2 and the horizontal plane H intersect with each other, and at the same time that the image capturing apparatus 1 can independently stand with the stand 9 at this time.

Next, the configuration of the stand 9 having desirable characteristics, described with reference to FIGS. 3A to 3D, will be described. FIG. 4A is an exploded perspective view of a stand hinge 900 according to a first embodiment. Note that the coordinate axes shown in FIG. 4A are drawn assuming that the stand 9 is in the accommodated state. The stand hinge 900 has the rotational plate 901, fixing members 902, friction plates 903, disc springs 904, and rotational shafts 905, as the main components.

The rotational plate 901 is a component which is a structure body of the stand 9 and has a substantially U-shape. The rotational plate 901 has a first beam 901a and a second beam 901b (two leg portions), and the first beam 901a and the second beam 901b each extend in a direction orthogonal to the rotational axis A2 (see FIG. 2C) and are arranged such that they are opposed to each other in the X direction. The first beam 901a and the second beam 901b are connected to each other via a third beam 901c (connection portion) at respective end portions on the +Y side, in a case where the stand 9 is in the accommodated state. In other words, the first beam 901a and the second beam 901b are connected via the third beam 901c at the respective end portions opposite from end portions through which the rotational axis A2 passes in the direction of the length. The rotational plate 901 is manufactured e.g. by pressing a sheet metal. That is, in the present embodiment, the first beam 901a, the second beam 901b, and the third beam 901c are integrally formed.

The first beam 901a, the second beam 901b, and the third beam 901c each have a plate-like and substantially rectangular shape (more specifically, a strip shape). The “strip shape” mentioned here refers to a shape in which, by setting two opposed sides as “one pair of sides”, and the length of one of the two pairs of sides is several times longer than the length of the other pair of sides. Regardless of whether the stand 9 is in the accommodated state or in a state rotated through a predetermined angle, the thickness direction of the first beam 901a and the second beam 901b is parallel to the rotational axis A2, and the thickness direction of the third beam 901c is orthogonal to the rotational axis A2.

The end portions of the first beam 901a and the second beam 901b (end portions on the −Y side in the case where the stand 9 is in the accommodated position), opposite from the end portions to which the third beam 901c is connected have respective holes 901aa and 901ba, as the center of the rotational axis A2, formed therethrough. Here, to hold the image capturing apparatus 1 in a tilted state, the stand 9 is required to have strength and torque for supporting the weight of the image capturing apparatus 1. Note that the torque of the stand 9 is a force for keeping the tilt angle, and specifically, is a force for maintaining a tilt angle so as to prevent, when the image capturing apparatus 1 is tilted and placed on a predetermined structure, the stand 9 from naturally rotating and changing the tilt angle of the image capturing apparatus 1. On the other hand, the user is required to perform the operation of rotating the stand 9 against the torque of the stand 9, and hence it is necessary to increase the strength of the rotational plate 901 in a direction of a force received by the stand 9 when the stand 9 is rotated.

To cope with this, the sheet metal component generally has high rigidity against a load applied from the side surface of the thickness and is difficult to be deformed, and hence the rotational plate 901 is manufactured by using this. That is, the rotational plate 901 ensures the high rigidity by designing the first beam 901a and the second beam 901b as described above. Further, the sheet metal component is generally smaller in thickness than the width of the sheet metal, and hence it is possible to prevent an increase in the size of the image capturing apparatus 1 in the thickness direction (Z direction) by designing the third beam 901c as described above. That is, since the rotational plate 901 is formed into the substantially U-shape by connecting the first beam 901a and the second beam 901b to each other via the third beam 901c, the rotational plate 901 has a structure which has high rigidity and is difficult to be deformed. In addition, on the rotational plate 901, it is possible to arrange the third beam 901c while preventing an increase in the size of the image capturing apparatus 1 in the thickness direction (Z direction).

Each fixing member 902 is a component fixed to the front cover 3 with a screw 902ba (see FIG. 4B) and is manufactured e.g. by pressing a sheet metal. The fixing member 902 is formed by a bearing portion 902a and a fixed portion 902b and has a substantially L-shape. The bearing portion 902a has a hole 902aa as the axial center of the rotational axis A2 and has a thickness the direction of which is parallel to the rotational axis A2. The fixed portion 902b extends from one end of the bearing portion 902a in a direction (X direction) parallel to the rotational axis A2, and its thickness direction is orthogonal to the rotational axis A2. The two fixing members 902 are arranged such that the fixed portions 902b symmetrically extend inward in the X direction inside the first beam 901a and the second beam 901b of the rotational plate 901, and that at the same time the holes 901aa and 901ba of the rotational plate 901 and the holes 902aa of the fixing member 902 are coaxially positioned.

Each rotational shaft 905 is a component which is the rotational shaft of the stand 9 and is manufactured e.g. by cutting metal. Each friction plate 903 and each disc springs 904 are arranged between the fixing member 902 and the rotational shaft 905. The hole 901aa of the first beam 901a, the hole 901ba of the second beam 901b, and the hole 902aa of the fixing member 902 are holes for inserting the rotational shaft 905. One of the two rotational shafts 905 is caulked from the outside of the first beam 901a in a state inserted from inside (between the first beam 901a and the second beam 901b) through the disc springs 904, the friction plate 903, the hole 902aa of the fixing member 902, and the hole 901aa of the first beam 901a. Similarly, the other one of the two rotational shafts 905 is caulked from the outside of the second beam 901b in a state inserted from inside through the disc springs 904, the friction plate 903, the hole 902aa of the fixing member 902, and the hole 901ba of the second beam 901b. Thus, the rotational axis A2 of the rotational plate 901 is formed.

The friction plate 903 and the disc springs 904 are fixed in a state deflected in the rotational axis direction (direction of extension of the rotational axis A2 (=X direction)) and thereby function as a torque generation section that generates torque applied when the rotational plate 901 is rotated. This torque is, specifically, a force (torque) for keeping the tilt angle so as to prevent, when the image capturing apparatus 1 is tilted and placed on a predetermined structure, the stand 9 from naturally rotating and changing the tilt angle of the image capturing apparatus 1. Thus, the rotational plate 901 is held in a state rotatable about the rotational axis A2 relative to the fixing member 902 and is held at a desired rotational position. Note that a click feeling can be generated at a desired rotational angle, by providing a recess portion (not shown) with which a protruding portion (not shown) of the friction plate 903 is engaged, in the vicinity of the hole 902aa of the fixing member 902.

FIG. 4B is an exploded perspective view of the stand 9. The stand 9 has the stand hinge 900, the stand side covers 91 and 92, the stand intermediate cover 93, the cushion member 94, and double-sided tapes 95, 96, and 97 for adhesively fixing each stand cover. The stand side covers 91 and 92 and the stand intermediate cover 93, forming the exterior of the image capturing apparatus 1, are molded of e.g. a resin material. The stand side covers 91 and 92 and the stand intermediate cover 93 are formed to cover the outside surface and the end faces of the rotational plate 901 and slightly protrude inward from the inner surface of the rotational plate 901. Although in the present embodiment, the exterior cover of the stand 9 is formed by the three components (three stand covers) of the stand side covers 91 and 92 and the stand intermediate cover 93, the exterior cover of the stand 9 can be a component which is integrally molded, considering the assemblability and/or a mold structure used for molding.

In a case where the rotational plate 901 is manufactured by pressing a sheet metal, a burr is generated on one of surfaces of the plate end, and a shear droop is generated on the other surface. Then, the burred surface of the rotational plate 901 is set to the outside to hide the burred surface with each stand cover. In this case, each stand cover slightly protrudes inward from the inner surface of the rotational plate 901 as described above, and hence the stand covers make the shear droop difficult to be viewed from the outside. This makes it possible to use the stand 9 without the user touching the burr and the shear droop of the rotational plate 901 while ensuring the properties of thinness, high strength, and high rigidity. That is, it is also possible to obtain an effect of ensuring the good appearance when the stand 9 is used (opened). Further, since it is unnecessary to remove a burr of the rotational plate 901, it is also possible to obtain an effect of reduction of the manufacturing costs.

As shown in FIG. 4B, the stand side covers 91 and 92 and the stand intermediate cover 93 are assembled to the rotational plate 901 of the stand hinge 900 from the outside, and are adhesively fixed by the double-sided tapes 95, 96, and 97, respectively. The shapes of the stand side cover 91 and the first beam 901a of the rotational plate 901, and the shapes of the stand side cover 92 and the second beam 901b of the rotational plate 901 are symmetrical with respect to a plane which is orthogonal to the rotational axis A2 and passes the center of the third beam 901c in the longitudinal direction. So, a relationship between the stand side covers 91 and 92, and the first beam 901a and the second beam 901b will be described based on the stand side cover 92 and the second beam 901b. A relationship between the stand side cover 91 and the first beam 901a is the same as the relationship between the stand side cover 92 and the second beam 901b, and hence description thereof is omitted.

Bosses 92b are formed inside the stand side cover 92. Further, the second beam 901b of the rotational plate 901 is formed with holes 901bb corresponding to the bosses 92b and half-punched portions 901bc which are recessed in the inner surface of the second beam 901b. The diameter of each half-punched portion 901bc is slightly larger than the diameter of each hole 901bb. After the bosses 92b are inserted through the holes 901bb of the second beam 901b, thermal caulking is performed on the bosses 92b inside the half-punched portions 901bc from the inside of the rotational plate 901, whereby the stand side cover 92 is rigidly fixed to the second beam 901b.

The stand intermediate cover 93 is fixed to the third beam 901c of the rotational plate 901 by sandwiching the cushion member 94 between the stand intermediate cover 93 and the third beam 901c of the rotational plate 901 and performing screw fastening from the outside. The cushion member 94 protrudes from the appearance surface of the stand intermediate cover 93 and is brought into contact with the rear surface of the display section 5 when the display section 5 and the stand 9 are both in the accommodated state. Note that although in the present embodiment, when the stand intermediate cover 93 is fixed to the rotational plate 901, screw fastening is used, the fixing method is not limited to this. For example, similar to the method of fixing the stand side cover 92, thermal caulking from the inside can be used. Further, although the cushion member 94 is prepared as a component separate from the stand intermediate cover 93, the cushion member 94 and the stand intermediate cover 93 can be formed as an integrated component by using two-color molding.

As described above, in the first embodiment, the stand 9 is formed by attaching the stand covers to the outside of the rotational plate 901 which is the sheet metal member. This makes it possible to realize the stand 9 having an appearance matching in shape with the front cover 3 and the rear cover 4, which makes it possible to enhance the design quality of the image capturing apparatus 1 and improve the appearance of the image capturing apparatus 1. Further, it is possible to improve gripping performance for the user. Further, since the inside of the rotational plate 901 is not covered by the stand covers, it is possible to prevent an increase in the size of the image capturing apparatus 1 in the X direction (width direction). Further, in a case where the stand 9 is in the rotated state, the user can visually recognize the rotational plate 901 from the outside. For example, by performing decoration processing, such as coating and plating, on the surface of the rotational plate 901, which is visually recognized, it is possible to improve the design quality in the rotated state.

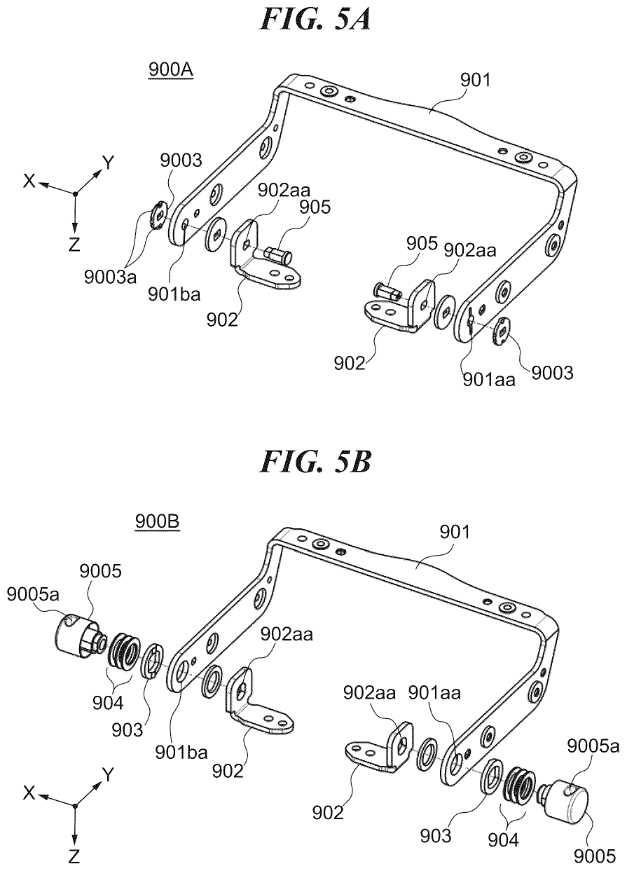

Next, a second embodiment will be described. FIG. 5A is an exploded perspective view of a stand hinge 900A according to the second embodiment, and the coordinate axes are drawn assuming that the stand 9 is in the accommodated state, similarly to FIGS. 4A and 4B.

Out of the components of the stand hinge 900A, the same components as the components of the stand hinge 900 of the first embodiment are denoted by the same reference numerals as in the first embodiment, and description thereof is omitted. Further, similar to those in the first embodiment, the stand side covers 91 and 92, and the stand intermediate cover 93 are also attached to the stand hinge 900A.

The second embodiment is different from the first embodiment in a configuration of applying the rotational torque to the stand 9. Specifically, in the second embodiment, each of the rotational shafts 905 is inserted from the inside of the fixing member 902 through the hole 902aa of the fixing member 902 and the hole 901aa (901ba) of the rotational plate 901, further inserted from the outside of the rotational plate 901 through a friction plate 9003, and then caulked from the outside.

The friction plate 9003 has the same function as the function of the friction plate 903 and the disc springs 904 in the first embodiment and is fixed in a state bent in the rotational axis direction, and protrusion portions 9003a formed on the friction plate 9003 are pressed against the rotational plate 901, whereby the rotational torque is applied to the rotational plate 901. That is, the friction plates 9003 are disposed between the rotational plate 901 and the stand side cover 91, and between the rotational plate 901 and the stand side cover 92, respectively, (since the stand side covers 91 and 92 are not shown in FIGS. 5A and 5B, see FIGS. 4A and 4B). With this, it is possible to use the internal space in the image capturing apparatus 1 for another use, and it is possible to reduce the size of the image capturing apparatus 1.

Next, a third embodiment will be described. FIG. 5B is an exploded perspective view of a stand hinge 900B according to the third embodiment, and similar to FIGS. 4A and 4B, the coordinate axes are drawn assuming that the stand 9 is in the accommodated state.

In the third embodiment, each rotational shaft 9005 is caulked from the inside of the fixing member 902 in a state inserted through the disc springs 904, the friction plate 903, the hole 901aa (901ba) of the rotational plate 901, and the hole 902aa of the fixing member 902, from the outside of the rotational plate 901, in the mentioned order. The friction plate 903 and the disc springs 904 are fixed in a state bent in the rotational axis direction, whereby the rotational torque is applied to the rotational plate 901.

The rotational shaft 9005 is a component serving as the axis of rotation of the stand 9 and is required to have high strength, and hence the rotational shaft 9005 is manufactured e.g. by cutting metal. In the present embodiment, a strap hole 9005a for inserting a strap string (not shown) is formed in each rotational shaft 9005. A member to which the strap string is attached is required to have sufficient strength so as not to be broken or separated even when the strap string is pulled. Therefore, it is desirable that the strap hole 9005a is integrally formed with the rotational shaft 9005. Note that the stand side covers 91 and 92 each have a hole formed therein for exposing part of the rotational shaft 9005, where the strap hole 9005a is formed, to the appearance. With this, even when the strap string is attached to the image capturing apparatus 1, the strap string is prevented from interfering with rotation of the stand 9.

Next, the configuration of the exterior of the image capturing apparatus 1 will be described. FIG. 6A is an exploded perspective view showing the components of the exterior of the image capturing apparatus 1 (as viewed from the +Z direction), and further shows the components of a front cover unit forming the exterior in an exploded perspective view (as viewed from the −Z direction). The image capturing apparatus 1 is formed by assembling a plurality of exterior units to an internal structure unit 70. The plurality of exterior units are the front cover unit 30, a rear cover unit 40, a top cover unit 60, the display section 5, and the stand 9.

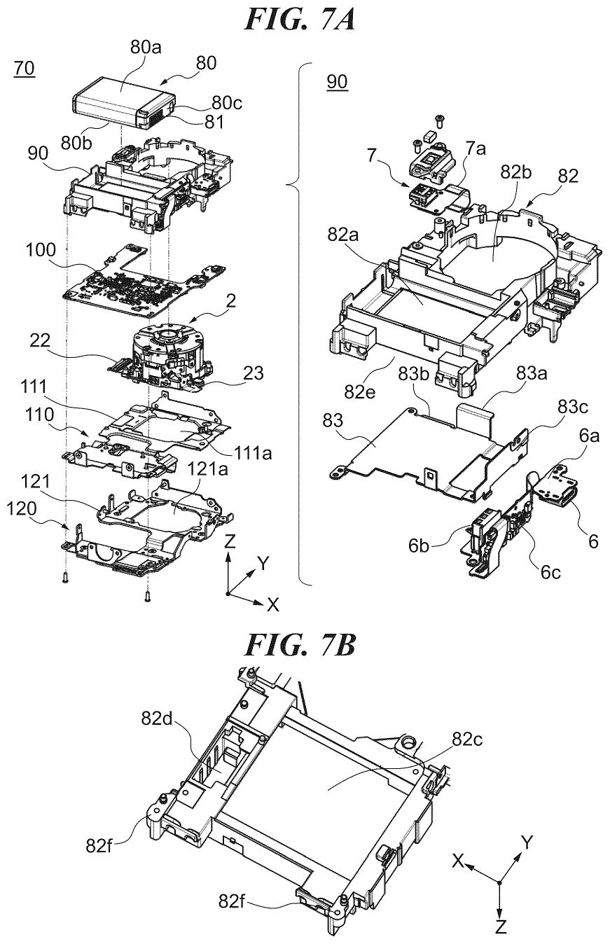

The internal structure unit 70 accommodates a battery 80. The battery 80 is plate-like and has a rectangular parallelepiped shape. Two surfaces of this rectangular parallelepiped body, opposed to each other, are defined as “one pair of surfaces”. The battery 80 is arranged such that one pair of a first surface 80a and a second surface 80b (see FIG. 7A), which are the largest in area out of the three pairs of surfaces, are substantially orthogonal to the Z direction (in other words, the thickness direction of the battery 80 is substantially parallel to the Z direction), and at the same time the longest sides are substantially parallel to the X direction. When the front cover unit 30 is removed, the first surface 80a of the battery 80 is exposed to the appearance, and the battery 80 is capable of being removed or replaced.

The front cover unit 30 is formed by the front cover 3 and components attached to the front cover 3. Inside (on the −Z side of) the front grip part 32 of the front cover 3, there are mounted the start/stop button 33, a front FPC 36 on which the switch of the start/stop button 33 is mounted, a front heat sink 37 holding the front FPC 36, and the tripod attaching portion 35. Note that the FPC refers to a flexible circuit board.

The front heat sink 37 is manufactured by pressing a sheet metal, such as aluminum or copper, which has a high thermal conductivity and a high strength. The front heat sink 37 is fastened to the front cover 3 from the inside with screws in a state in which the front FPC 36 has been assembled to the front cover 3. The front heat sink 37 is arranged to cover the first surface 80a of the battery 80. The sheet metal member used for the front heat sink 37 can ensure the rigidity even when it is thinner in thickness than a resin member. With this front heat sink 37, it is possible to reduce the size of the image capturing apparatus 1 in the thickness direction (Z direction) while ensuring the shape regulating the position of the battery 80 in the Z direction.

The tripod attaching portion 35 is disposed in the vicinity of the bottom surface of the apparatus body. The tripod attaching portion 35 has a tripod screw portion 35a. The standards of a screw shape and a screw depth are defined by the JIS standards, and hence the tripod screw portion 35a can be slightly reduced in size depending on a material but cannot be significantly reduced in size. Note that the tripod screw portion 35a functions as an accessory attachment/removal portion to which and from which an accessory (such as an illumination device) having a screw conforming to the standards can be attached and removed. An accessory other than the tripod is not necessarily inhibited from being attached and removed to and from the tripod screw portion 35a. The tripod attaching portion 35 is fastened to the front cover 3 with screws from inside in a state sandwiching the front heat sink 37 between itself and the front cover 3. Thus, conduction is secured between the tripod attaching portion 35 and the front heat sink 37. The tripod attaching portion 35 is only required to be a member which can ensure mechanical strength and at the same time can be formed into a necessary shape, and can be made of a sheet metal or can be die cast.

FIG. 6B is a rear view showing a state of the stand 9 fixed to the front cover unit 30. The fixing members 902 of the stand 9 are arranged in spaces on left and right sides (±X sides) of the tripod screw portion 35a difficult to be reduced in size. This makes it possible to dispose the stand 9 rotatably with respect to the apparatus body without increasing the size of the image capturing apparatus 1. At this time, naturally, the rotational axis A2 is arranged such that the rotational axis A2 partially overlaps the tripod screw portion 35a on a projection plane as viewed in the Z direction.

The fixing members 902 are fastened to the front cover 3 with screws from inside in a state sandwiching the front heat sink 37 between itself and the front cover 3. Thus, conduction is secured between the stand hinge 900 and the front heat sink 37. That is, the stand hinge 900 is electrically connected to the tripod attaching portion 35 via the front heat sink 37. In the present embodiment, although the stand hinge 900 is fastened to the front cover 3 with screws, the stand hinge 900 can be directly fastened to the tripod attaching portion 35 with screws. The fixed portion 902b of the fixing member 902 is disposed more on the front side of the apparatus body than the rotational axis A2 (on the +Z side of the rotational axis A2) with respect to a direction orthogonal to the optical axis L. This makes it possible to use a space on the −Z side of the fixed portions 902b for screw seats 82f (see FIG. 7B) for fixing a main board 100 (see FIG. 7A) which is a control board for controlling the image capturing apparatus 1.

Next, the configuration of the internal structure unit 70 of the image capturing apparatus 1 will be described. FIG. 7A is an exploded perspective view showing the components of the internal structure unit 70 of the image capturing apparatus 1, and further shows the components of a main base unit 90 forming the internal structure unit 70, in an exploded perspective view. The internal structure unit 70 has the main base unit 90, the barrel unit 2 assembled to the main base unit 90, the battery 80, the main board 100, a rear heat sink unit 110, and a main chassis unit 120. 7A) which is a control board for controlling the image capturing apparatus 1.

A main base 82 is a component serving as the base of the main base unit 90 and is formed of a resin material. The main base 82 has a battery chamber 82a formed therein for accommodating the battery 80 and a barrel chamber 82b formed therein for accommodating the barrel unit 2. The battery chamber 82a is provided within a range of the front grip part 32 (see FIG. 1A) on a projection plane as viewed in the Z direction.

FIG. 7B is a perspective view of part of the main base 82 on the −Y side, as viewed from the −Z side. In the battery chamber 82a, a surface opposed to the second surface 80b of the battery 80 has a cutout portion (opening) 82c formed therein, and an intermediate heat sink 83 is arranged such that the intermediate heat sink 83 covers the cutout portion 82c. The intermediate heat sink 83 is a sheet metal member and can ensure the rigidity even when the sheet metal member is thinner than a resin material. With this configuration, it is possible to reduce the size of the battery chamber 82a in the thickness direction (Z direction) while ensuring the shape regulating the position of the battery 80 in the Z direction.

The intermediate heat sink 83 is provided with a first extending portion 83a and a second extending portion 83b, which are formed by bending such that the first extending portion 83a and the second extending portion 83b extend in the Z direction between the battery chamber 82a and the barrel chamber 82b in the Y direction. The first extending portion 83a is extended toward the front cover 3 (+Z side) in the Z direction, and is configured to be capable of transferring heat to the front heat sink 37 (see FIGS. 6A and 6B). The second extending portion 83b is extended toward the rear cover 4 (−Z side) in the Z direction and is configured to be capable of transferring heat from the main board 100. With this arrangement, heat generated in the main board 100 is transferred from the second extending portion 83b to the intermediate heat sink 83 to be diffused between the main board 100 and the battery 80, and is then further transferred from the first extending portion 83a to the front heat sink 37. Thus, it is possible to diffuse heat to the +Z side of the main board 100.

On the outer periphery of the barrel chamber 82b, there are arranged the external connector 6 that is connected to an external apparatus to transfer data and receive power supply for charging the battery 80, and the HDMI connector 7 that causes an external display device to display a video. As the external connector 6, a USB connector is used, for example. The HDMI connector 7 is mounted on a first connector FPC 7a and is connected to the main board 100. The external connector 6 is mounted on a second connector FPC 6a and is connected to the main board 100. The second connector FPC 6a has a battery connector 6b electrically connected to the battery 80 and a power supply circuit area 6c on which a device associated with a power supply circuit, such as a charging IC, is mounted.

In the battery 80, a third surface 80c, which is one of the pair of surfaces orthogonal to the X direction, is provided with a contact portion 81 connected to the battery connector 6b. A surface of the main base 82, which is opposed to the third surface 80c, has a battery connector space 82d formed therein for accommodating the battery connector 6b.

The intermediate heat sink 83 has a third extending portion 83c formed therein which is parallel to the third surface 80c of the battery 80 and extends on the +X side of the battery connector space 82d. The power supply circuit area 6c of the second connector FPC 6a is fixed such that it is brought into contact with the third extending portion 83c. This makes it possible to transfer heat generated in the power supply circuit to the intermediate heat sink 83.

On the −Y side of the battery chamber 82a of the main base 82, a tripod chamber 82e is formed in which the tripod attaching portion 35 is disposed. Further, on the main base 82, the screw seats 82f for fixing the main board 100, a rear heat sink 111, and a main chassis 121 with screws are provided in respective spaces on left and right sides (±X sides) of the tripod chamber 82e. The screw seats 82f overlap the fixing members 902 (see FIG. 6B) of the stand 9 on a projection plane as viewed in the Z direction, but can be arranged by differentiating the positions thereof from the fixing members 902 in the Z direction.

The main board 100 has mounted thereon a CPU as a central processing unit that performs the overall control of the image capturing apparatus 1 and connectors for electrically connecting the connector FPCs. The main board 100 is fixed to the main base 82 such that it is orthogonal to the optical axis L and has a substantially U-shape, as viewed in the optical axis direction. On the rear side (−Z side) of the barrel unit 2, there is disposed the image sensor 21 (see FIG. 8C), such as a CCD sensor or a CMOS sensor, that generates image data by photoelectrically converting an optical image. Note that the image sensor 21 is mounted on a sensor FPC 22. Inside the barrel unit 2, actuators (not shown), such as a shutter mechanism and a focus mechanism, are arranged, and each actuator is mounted on an actuator FPC 23.

The rear heat sink unit 110 has the rear heat sink 111, a wireless communication board (not shown), and a wireless FPC (not shown). The rear heat sink 111 is made by pressing a sheet metal, such as aluminum or copper, which has a high thermal conductivity and a high strength. The wireless communication board performs wireless communication with an external apparatus. The wireless FPC electrically connects between the wireless communication board and the main board 100.

The main chassis unit 120 has the main chassis 121 which is the structure body of the image capturing apparatus 1 and forms the main GND (ground), and a rear operation board (not shown) on which switches of the rear operation section 41 have been mounted. The main chassis 121 is manufactured by pressing a sheet metal. The main chassis 121 has an opening 121a formed around the area of the rear surface of the image sensor 21. The rear heat sink 111 has an drawing portion 111a formed therein which enters the opening 121a. The aperture portion 111a is disposed such that it is received within the thickness of the opening 121a of the main chassis 121.

An end of the barrel unit 2 on the −Z side is the rear surface of the sensor FPC 22. Therefore, by forming the opening 121a in the main chassis 121 and disposing the aperture portion 111a of the rear heat sink 111 inside the opening 121a, it is possible to diffuse heat generated in the image sensor 21 mounted on the sensor FPC 22 while reducing the size of the image capturing apparatus 1 in the thickness direction (Z direction).

The barrel unit 2 is assembled in the barrel chamber 82b of the main base 82 after the main board 100 has been assembled in the main base unit 90, and the sensor FPC 22 and the actuator FPC 23 are connected to the connectors of the main board 100. Then, the rear heat sink unit 110 and the main chassis unit 120 are assembled and fastened with screws at the screw seats 82f formed on the main base 82, in a state sandwiching the main board 100. After that, the rear heat sink unit 110 and the main chassis unit 120 are fastened to the main base 82 with screws at a plurality of locations around the barrel chamber 82b, and further fastened to the tripod attaching portion 35 of the front cover unit 30 with screws at a plurality of locations from the bottom side. Thus, the barrel unit 2 is sandwiched and held between the main base 82 and the main chassis 121 via an elastic member (not shown). This makes it possible to realize the configuration which prevents vibration caused by the actuators in the barrel unit 2 and the like from affecting sound collection performed by the microphone arranged in the image capturing apparatus 1.

FIGS. 8A to 8C are views useful in explaining a layout of the components in the internal structure unit 70 of the image capturing apparatus 1. FIG. 8A is a front view of the image capturing apparatus 1. FIG. 8B is a cross-sectional view taken along CC-CC in FIG. 8A, including a cross section of the bearing portion 902a of the fixing member 902 of the stand 9.

The stand 9 is required to keep the tilted state of the image capturing apparatus 1, and hence the holding torque having the rotational axis A2 of the stand 9 as the center is needed to exceed the rotational torque applied by the self-weight of the image capturing apparatus 1, which is generated in the center of gravity of the image capturing apparatus 1. Therefore, the minimum holding torque necessary for the stand 9 is mostly determined by the position of the center of gravity of the image capturing apparatus 1 and the weight of the image capturing apparatus 1. Although the holding torque is determined by the outer diameter of the friction plate 903 (see FIG. 4A) and the pressing force of the disc spring 904 (see FIG. 4A), in the present embodiment, the holding torque is determined by suppressing the pressing force of the disc spring 904 through consideration of the durability performance of the stand 9 and adjusting the outer diameter of the friction plate 903.

Specifically, a bearing area S of the bearing portion 902a is set to a size covering the outer diameter of the friction plate 903 on a projection plane as viewed in the Z direction, and the outer diameter of the disc spring 904 is set to be smaller than the outer diameter of the friction plate 903. Here, the bearing area S is an internal structure member for generating the holding torque of the stand 9. If the internal structure member appears on the appearance, the appearance is degraded, and the design quality is lowered. For this reason, to prevent the bearing area S from appearing on the appearance of a finished product of the image capturing apparatus 1, it is necessary to cover the bearing area S with the stand side covers 91 and 92 assembled to the rotational plate 901 of the stand 9. Therefore, it is desirable to make the bearing area S to the possible extent.

FIG. 8C is a cross-sectional view taken along BB-BB in FIG. 8A, i.e. a cross-sectional view of part of the image capturing apparatus 1 on the −Y side of the optical axis L. The part of the image capturing apparatus 1 on the −Y side is a grip part formed by the front grip part 32 and the rear grip part 42, and on the other hand, part of the image capturing apparatus 1 on the +Y side is a non-grip part on which the barrel unit 2 and the display section 5 occupy most of the weight ratio. In the present embodiment, the components are disposed in the non-grip part at a high density so as to reduce the size of the image capturing apparatus 1, and therefore, the center position of each of the respective shapes of the display section 5 and the barrel unit 2 can be considered as substantially the center of gravity of the non-grip part. That is, it can be considered that the position of a gravity center CZ1 of the non-grip part of the image capturing apparatus 1 in the Z direction is the center position of the shape formed by combining the barrel unit 2 and the display section 5.

On the other hand, on the grip part positioned on the −Y side of the image capturing apparatus 1, the battery 80, the main board 100, the rear heat sink 111, and the main chassis 121 are main components which occupy most of the weight ratio of the grip part of the image capturing apparatus 1. The main board 100 and the rear heat sink 111 are arranged close to each other between the battery 80 and the main chassis 121, and hence the center position of the shape of each of the battery 80 and the main chassis 121 can be considered as the center of gravity. That is, it can be considered that the position of a gravity center CZ2 of the grip part of the image capturing apparatus 1 in the Z direction is the center position of the shape formed by the battery 80 and the main chassis 121.

The image capturing apparatus 1 is designed such that the barrel unit 2, the battery 80, and the tripod attaching portion 35 are arranged from the +Y side to the −Y side in the mentioned order, and at the same time a positional center CZ3 of the shape of the barrel unit 2, a positional center CZ80 of the shape of the battery 80, and a positional center CZ35 of the shape of the tripod attaching portion 35, in the Z direction, are accommodated in the range of the bearing area S of the stand 9. Further, the image capturing apparatus 1 is designed such that the gravity center CZ1 of the non-grip part in the Z direction and the gravity center CZ2 of the grip part in the Z direction are accommodated in the range of the bearing area S of the stand 9. As a result, the center of gravity of the image capturing apparatus 1 naturally enters within the range of the bearing area S of the stand 9 in the Z direction. With this configuration, the center of gravity of the image capturing apparatus 1 and the center of the rotational axis A2 are in a positional relationship of being close to each other in the Z direction, and hence it is possible to equalize the tilt angle ranges at the time of low-angle shooting and at the time of high-angle shooting.

As described above with reference to FIGS. 6A and 6B, the fixing members 902 are arranged such that the stand 9 is bridged over the tripod screw portion 35a. Then, the rotational axis A2 penetrates the tripod screw portion 35a on a projection plane as viewed in the Z direction. That is, the tripod screw portion 35a is arranged such that the positional center CZ35 of the shape of the tripod attaching portion 35 is naturally accommodated in the range of the bearing area S of the stand 9. As mentioned above, since the standards of the screw shape and the screw depth are defined by the JIS standards, it is impossible to largely reduce the size of the tripod screw portion 35a. Further, to generate the holding torque Ts for supporting the image capturing apparatus 1 against the rotational torque applied by the self-weight of the image capturing apparatus 1, the bearing area S of the stand 9 is not easy to be reduced in size. So, in the present embodiment, the tripod screw portion 35a and the bearing portion 902a of the fixing member 902 of the stand 9, which are difficult to be reduced in size, are designed such that they overlap each other on a projection plane as viewed in the X direction. This makes it possible to reduce the size of the image capturing apparatus 1 in the Y direction, and lower the center of gravity of the image capturing apparatus 1.

The position of the end of the barrel unit 2 on the −Z side is a rear position Z22 of the sensor FPC 22 of the image sensor 21. The barrel unit 2 is assembled from the −Z side of the main board 100. The sensor FPC 22 is connected to the connector on the main board 100, and hence the rear position Z22 of the sensor FPC 22 is positioned on the −Z side (rearward) of a rear position Z100 of the main board 100. On the −Z side of the sensor FPC 22, only the aperture portion 111a of the rear heat sink 111, the rear cover 4, and the display section 5 are arranged, and this can be said as the necessary minimum configuration.

Incidentally, in the Z direction as the thickness direction of the image capturing apparatus 1, if an accommodated position Z93 of the stand intermediate cover 93 is located on the −Z side (rearward) of a rear position Z4 of the rear cover 4 covered by the display section 5, the image capturing apparatus 1 is increased in size in the thickness direction. To avoid this problem, the following measure is taken for the image capturing apparatus 1:

In a case where the stand 9 is in the accommodated state, and at the same time, the display section 5 is also in the accommodated state, the stand intermediate cover 93 is hidden by the display section 5. That is, in the case where the display section 5 and the stand 9 are both in the accommodated state, the stand intermediate cover 93 is in a state positioned on the +Y side of a lower end position Y5 of the display section 5 in the Y direction. An upper end position Y93 of the stand intermediate cover 93 when the stand 9 is in the accommodated state is positioned on the −Y side of a lower end position Y22 of the sensor FPC 22. That is, the stand intermediate cover 93 and the sensor FPC 22 are arranged at locations where they do not overlap each other on a projection plane as viewed in the Z direction.

This makes it is possible to position an inner position Z49 of the stand accommodating portion 49 of the rear cover 4 on the +Z side of the rear position Z22 of the sensor FPC 22 in the Z direction. As a result, it is possible to secure a space which is deep in the Z direction as the stand accommodating portion 49 of the rear cover 4 and accommodate the stand intermediate cover 93 in the stand accommodating portion 49. Further, when the stand 9 is in the accommodated state, the stand intermediate cover 93 is hidden by the display section 5. Therefore, the appearance in a case where the image capturing apparatus 1 is viewed from the rear is improved, and the stand 9 is prevented from interfering with the user holding the grip part. Further, the distance D2 (see FIG. 3B) from the rotational axis A2 to the cushion member 94 and the distance D4 (see FIG. 3D) from the rotational axis A2 to the fillets 91a and 92a can be secured as long distances.

By configuring the stand 9 as described above, it is possible to lengthen the distances D2 and D4 related to the stand 9 while realizing size reduction of the image capturing apparatus 1 in the thickness direction, and hence it is also possible to extend the tilt angle ranges of the image capturing apparatus 1 at the time of low-angle shooting and at the time of high-angle shooting. Further, according to the present embodiment, it is possible to improve the stability of the image capturing apparatus 1 when low-angle shooting and high-angle shooting are performed, by causing the image capturing apparatus 1 to independently stand using the stand 9, while realizing miniaturization of the image capturing apparatus 1.

Further, the stand accommodating portion 49 of the rear cover 4 is close to the main board 100, and hence the stand accommodating portion 49 is liable to become high in surface temperature due to heat generated by a variety of electronic components mounted on the main board 100. So, a heat transfer area J for transferring heat generated in the main board 100 to the +Z side is provided. The heat transfer area J is disposed in an area located between the barrel unit 2 and the battery 80 and at the same time overlapping the stand accommodating portion 49 on a projection plane as viewed in the Z direction. The heat transfer area J is configured such that the heat generated in the main board 100 is transferred from the main board 100 to the front heat sink 37, for diffusion, by the first extending portion 83a and the second extending portion 83b of the intermediate heat sink 83. With this, even if the stand accommodating portion 49 of the rear cover 4 is formed deep (largely recessed toward the +Z side), it is possible to prevent rise of the surface temperature of the stand accommodating portion 49.

The present disclosure can also be accomplished by supplying a program for realizing one or more functions of the above-described embodiment to a system or an apparatus via a network or a storage medium, and one or more processors of a computer in the system or the apparatus reading and executing the program. Further, the present disclosure can also be accomplished by a circuit (such as an ASIC) that realizes one or more functions.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

### REFERENCE SIGNS LIST

1 image capturing apparatus
2 lens barrel unit
5 display section
9 stand
35 tripod attaching portion
35a tripod screw portion
49 stand accommodating portion
80 battery
82f screw seat
100 main board
900 stand hinge
901 rotational plate
901a first beam
901b second beam
901c third beam
902 fixing member
903 friction plate
904 disc spring
905 rotational shaft

1. An image capturing apparatus comprising:
a barrel unit;
an accessory attachment/removal portion disposed in a second direction orthogonal to a first direction which is an optical axis direction of the barrel unit, with respect to the barrel unit, for attaching and removing an accessory;
a battery disposed between the barrel unit and the attachment/removal portion in the second direction; and
a stand rotatably held about a stand rotational axis, as a center, which is parallel to a third direction orthogonal to the first direction and the second direction,
wherein the battery has a plate shape and is disposed such that a thickness direction thereof is parallel to the first direction,
wherein the stand has two leg portions disposed at respective ends of the image capturing apparatus in the third direction, and a connection portion connecting the two legs in the third direction,
wherein the accessory attachment/removal portion is exposed to appearance in a bottom surface of the image capturing apparatus, and
wherein the stand rotational axis overlaps the accessory attachment/removal portion on a projection plane as viewed in the third direction, and at the same time, overlaps the accessory attachment/removal portion, the battery, and the barrel unit on a projection plane as viewed in the second direction.

2. The image forming apparatus according to claim 1, wherein the stand includes:
a rotational plate having a substantially U shape and including a first beam and a second beam forming the two leg portions, which are arranged substantially parallel at ends of the image capturing apparatus in the third direction, and a third beam connecting an end of the first beam and an end of the second beam, which forms the connection portion,
fixing members fixed to a main body of the image capturing apparatus and rotatably holding the rotational plate, and
covers attached to the first beam, the second beam, and the third beam.

3. The image forming apparatus according to claim 2, wherein the rotational plate is a sheet metal member in which the first beam, the second beam, and the third beam are integrally formed.

4. The image forming apparatus according to claim 2, wherein the fixing members each include:
a bearing portion which is orthogonal to the stand rotational axis and to which the rotational plate is rotatably attached, and
a fixing portion extending from an end of the bearing portion in a direction parallel to the stand rotational axis, and
wherein the fixing portions are positioned more on a front side of the image capturing apparatus than the stand rotational axis in the first direction, and the fixing members are disposed in an opposed state in the third direction with the accessory attachment/removal portion therebetween such that the fixing portions face toward the accessory attachment/removal portion.

5. The image forming apparatus according to claim 4, wherein the bearing portion and the accessory attachment/removal portion overlap on a projection plane as viewed in the third direction.

6. The image forming apparatus according to claim 4, wherein the main body has a control board for controlling the image capturing apparatus, and
wherein the control board is disposed more on a rear side of the image capturing apparatus than the battery.

7. The image forming apparatus according to claim 4, wherein the main body has an accommodation portion for accommodating the third beam, and part, which covers the third beam, of the cover, in an accommodated state of the stand in which the first beam and the second beam overlap the main body on a projection plane as viewed in the third direction,
wherein the barrel unit has a flexible board on which an image sensor is mounted, and
wherein the accommodation portion is disposed more on a bottom side of the image capturing apparatus than the flexible board in the second direction.

8. The image forming apparatus according to claim 7, wherein a heat transfer area for transferring heat generated in the control board to a front side of the image capturing apparatus is an area which is between the barrel unit and the battery in the second direction, and at the same time is provided in an area overlapping the accommodation portion on a projection plane as viewed in the first direction.

9. The image forming apparatus according to claim 7, wherein the third beam is plate-like and has a rectangular shape, and a thickness direction of the stand is orthogonal to the third direction when the stand in the accommodated state, and
wherein in the accommodated state, out of surfaces, orthogonal to the first direction, of the third beam, one opposed to the main body is not covered by part, covering the third beam, of the cover.

10. The image forming apparatus according to claim 7, wherein in a case where the stand is in the accommodated state, the third beam, and part, covering the third beam, of the cover are positioned more on a rear side of the image capturing apparatus than the stand rotational axis, in the first direction.

11. The image forming apparatus according to claim 7, further comprising a display section provided on a rear side of the main body in a state rotatable about a display section rotational axis provided in the vicinity of a top surface of the main body in parallel to the third direction, and
wherein when a screen of the display section is substantially orthogonal to the first direction and the display section is in a state overlapping the main body on a projection plane as viewed in the first direction, and at the same time, the stand is in the accommodated state, part, covering the third beam, of the cover is covered by the display section.

12. The image forming apparatus according to claim 6, wherein, screw seats for fixing the control board inside the image capturing apparatus are provided more on a rear side of the image capturing apparatus than the fixing portions, such that the screw seats overlap the fixing portions on a projection plane as viewed in the first direction.

13. The image forming apparatus according to claim 4, wherein the stand includes:
shafts serving as the stand rotational axis, and
a torque generation section through which the shafts are inserted, and
wherein the first beam, the second beam, and the bearing portions have hole through which the shafts are inserted, and
wherein the torque generation section is provided between the first beam, and part, covering the first beam, of the cover, and between the second beam, and part, covering the second beam, of the cover.

14. The image forming apparatus according to claim 13, wherein the torque generation section is formed by friction plates and disc springs.

15. The image forming apparatus according to claim 13, wherein the torque generation section is provided within a range of the fixing portions on a projection plane as viewed in the third direction.

16. The image forming apparatus according to claim 13, wherein the shafts have strap holes through which strap strings are passed, and
wherein part, covering the first beam, of the cover, and part, covering the second cover, of the cover have openings for exposing portions of the shafts where the strap holes are formed to an appearance.

17. The image forming apparatus according to claim 2, wherein the cover includes:
a first cover attached to the first beam for covering the first beam,
a second cover attached to the second beam for covering the second beam, and
a third cover attached to the third beam for covering the third beam.
